(19) United States
(12) Patent Application Publication
(10) Pub. No.: US 2002/0036367 A1
(43) Pub. Date: Mar. 28, 2002

(54) Method for producing & manufacturing density enhanced, DMC, bonded permanent magnets

(76) Inventors: Marlin Walmer, Lancaster, PA (US); Michael Walmer, Washington Bon, PA (US); Jinfang Liu, Lancaster, PA (US)

Correspondence Address: BANNER & WITCOFF, LTD., 28 STATE STREET, 28th FLOOR, BOSTON, MA, 02109, US

(21) Appl. No.: 09/782,712

(22) Filed: Feb. 13, 2001

Related U.S. Application Data
(60) Provisional application No. 60/183,941, filed on Feb. 22, 2000.

(51) Int. Cl. H05B 6/00

(52) U.S. Cl. 264/427; 264/429; 264/460

(57) ABSTRACT

Disclosed is a method of manufacturing density enhanced, bonded permanent magnets having the following properties:

a. maximum energy product (BH)ₘₐₓ up to 40% greater than that of traditional, mechanical, compacted, bonded permanent magnets,

b. (BH)ₘₐₓ up to 99% of theoretical,

c. void ratio approaching 0 volume %, and

d. use temperature from room temperature up to about 550° C.,

said method comprising the step of compacting a mixture of permanent magnet particulates and a binder using pulsed electromagnetic forces, where each pulse has a pulse time less than the thermal time constant of the permanent magnet particulate, and wherein said compaction is achieved without adversely affecting the binder or the structure of the permanent magnet particulates.

### CROSS-REFERENCE TO RELATED APPLICATIONS

This application claims priority from copending Provisional Application, U.S. Ser. No. 60/183,941, filed Feb. 20, 2000, the disclosure of which is hereby incorporated herein by reference. This application is also related to copending application Ser. No. 09/______, filed on even date herewith under Attorney Docket No. 4928/00002, which is hereby incorporated herein by reference.

### BACKGROUND OF THE INVENTION

Permanent magnets are ubiquitous in modern societies. Devices which use permanent magnets include motors, sensors, actuators, acoustic transducers, etc. These are used in home appliances, speakers, office automation equipment, medical laboratory diagnostic test equipment, computers, disk drives, cell phones, etc.

Of the many permanent magnet materials, four are predominant in use: alnico, ferrite, samarium cobalt and neodymium-iron-boron (NdFeB or “neo”). Nio was invented and commercialized in the early 1940s. Ferrite magnets, also called ceramic, were first commercialized in 1952. Samarium-cobalt was introduced in the late 1960s and an improved composition, Sm₂Co₁₇, provided by the early 1970s. The most recently developed material is neodymium-iron-boron and was first available in 1984. Both these latter materials belong to the family of rare earth magnets.

Each magnet type has unique properties that make it more suitable for selected applications than other magnet options. Selection criteria include: magnetic strength, cost, constancy of magnetic output over temperature extremes, corrosion resistance, resistance to demagnetization, and mechanical properties such as density, physical strength or flexibility. Ferrite magnets, while providing less magnetic strength than rare earth magnets, cost far less. Therefore, they are still widely used wherever product cost is a major consideration over magnetic performance.

Some examples of applications served primarily by a certain magnet type are: voice coil motors which use “neo”magnets for positioning read/write heads in computer hard disk drives; high temperature automotive sensors use samarium cobalt; beam focusing devices, such as traveling wave tubes, use alnico, and samarium cobalt, etc.

There are several manufacturing technologies for these permanent magnet materials. Alnico is manufactured by a foundry process of melting alloy and pouring it into molds producing near net shape. These cast magnets are then ground for precise dimension. In order to make parts which are too small for the casting process; cast alnico is pulverized, mixed with additional ingredients, pressed in dies, and sintered. Ferrites and rare earth magnets are manufactured using powder metallurgy processes including milling to fine particle size, pressing, sintering, and cutting/grinding to final dimensions.

Since the 1970s, another form of permanent magnet has become commonplace: the bonded permanent magnet. Originally made from ferrite powders and in flexible form, recent developments include the use of rare earth materials and the technologies of injection molding, compression bonding and extrusion.

Bonded magnets constitute a significant and growing fraction of the permanent magnet market worldwide. These materials are manufactured by blending or encapsulating a magnetic particulate in a binder and then compacting or molding the mixture into the final part shape. Depending on the nature of the binder and the type of processing employed, both magnetically isotropic and anisotropic bonded magnets can be manufactured. Owing to the presence of the binder, the magnetic remnants and energy product of bonded magnets are always lower than that of their fully dense, binder-free counterparts. The principle advantages of bonded magnets are, however, their greatly superior mechanical properties and the fact that net shape parts of high tolerance can be easily prepared. For this reason they have become a design requirement in applications where these attributes are of overriding importance. A particularly important development in this area has been the discovery and rapid growth of isotropic bonded neodymium magnets which are produced from rapidly solidified powders. These materials are now a key design feature in a wide range of high technology, high growth applications, notably, spindle and stepper motors for the computer peripheral and consumer electronics industry, as well as for biomedical applications.

The binder that holds the magnetic particles in place may produce either a flexible or a rigid magnet. Typical binders for flexible magnets are elastomers, such as nitrile rubber and vinyl. Binders for rigid magnets include metallic binders, thermoplastic and thermosetting binders including: nylon, PPS (polyphenylene sulfide), polyester, Teflon and epoxies. The thermoplastic binder and magnetic particulate mixture may be formed into various complex shapes via injection molding or extrusion. A major advantage of the bonded process is manufacturing to net shape. If necessary, secondary operations such as drilling, slicing and gluing can be easily performed. Another advantage of injection molding is the ability to mold onto another object such as a staff or shaft, a hub or into a can.

There are four processes suitable for manufacturing bonded magnets. These processes are calendering, injection molding, extrusion and compression bonding. The first three processes use various thermoplastic or elastomer compounds in mixture with the magnet particulate.

Bonded magnets are growing faster than the magnet industry as a whole. Among the reasons for this are: (1) bonded magnets provide an almost infinite variety of combinations of mechanical, physical and magnetic properties, (2) injection molding enables complex geometries, net shape processing and magnet assembly by insert or over molding, (3) compression molding tooling costs are relatively low; (4) handling is relatively easy, and (5) assembly is simple via gluing or press fitting. This growth can be improved even further, if bonded permanent magnets can be developed with higher densities, i.e., increases in (BH)ₘₐₓ of up to 40%, and at least about 26%, and higher use temperatures, i.e., use temperatures up to 550° C.

The initial development of permanent rare earth magnets has been driven by various industrial applications as set out below, along with their respective approximate use temperatures in degrees Centigrade:

Inertial devices (−50° C. to 150° C.)

Medical tools (up to 200° C.)

Traveling Ware Tubes (TWT) (up to 300° C.)

Actuators, inductors, inverters, magnetic bearings, and regulators (up to 300° C.)

Motors and generators (up to 325° C.)

The magnets useful in these applications are characterized by: (a) high Curie temperature, T_{c}, (b) high crystalline anisotropy, (c) high maximum energy product with high induction and high coercive force, and (d) good corrosion resistance. These magnets are used primarily to produce a magnetic flux field in various devices.

The magnetic strength of these magnets available for use in various devices is dependent upon the maximum energy product (BH)ₘₐₓ. The higher the (BH)ₘₐₓ the more energy available for use in the device and the more commercially valuable the magnet.

One measure of the resistance of a magnet to demagnetization is intrinsic coercivity, _{I}H_{C} which is particularly important for bonded permanent magnets used in elevated temperature applications. A high _{I}H_{C} and a small temperature coefficient of _{I}H_{C} are signs of high thermal stability of bonded magnets. For high temperature applications, a small temperature coefficient of ᵢH_{C} is imperative and was not available in previous bonded magnets.

The discovery and evolution of rare earth permanent magnet particulates suitable for use in bonded magnets are chronicled in global conference series, which include “International Workshops on Rare Earth Magnets and Their Applications”, MMM (Magnetism and Magnetic Materials) conferences, INTERMAG (International Magnetic Conferences) and other conferences held from 1964 through 1999. The official published proceedings of these conferences are hereby incorporated by reference.

Rare earth magnet alloy systems with high coercivity in conjunction with high induction and high magnetocrystalline anisotropy were discovered in the early 1960s by K. Strnat and his colleagues. Seminal papers in this area include:

K. Strnat and W. Ostertag, “Program for an in-house investigation of the yttrium-cobalt alloy system”, Technical Memorandum, May 64-4, Projects 7367 and 7360, AFML, Wright-Patterson AFB, Ohio, March, (1964).

K. Strnat and G. Hoffer, “YCo₅—A promising New Permanent Magnet

Material”, USAF Tech. Doc. Rept., Materials Laboratory, WPAFB AFML-TR-65-446, May (1966).

G. Hoffer and K. Strnat, “Magnetocrystalline Anisotropy of YCO₅ and Y₂Co₁₇”, IEEE Trans. Magn., Mag-2, 487, Sept., (1966).

K. Strnat, G. Hoff, J. Olson, W. Ostertag, and J. Becker, “A family of new cobalt-base permanent magnet material”, J. Appl. Phys. 38 1001, (1967).

D. Das, “Twenty million energy product samarium-cobalt magnet”, IEEE Trans., Magn., Mag-5, 214, (1969).

M. Benz and D. Martin, “Cobalt-samarium permanent magnets prepared by liquid phase sintering”, Appl. Phys. Lett., 17, 176 (1970).

Starting in about 1966, there have been numerous papers, patents, and books published on research and development of the rare earth permanent magnets. RECo₅ type sintered materials were commercialized in 1968. RE₂TM₁₇ type materials were commercially available by the middle of the 1970s. RE represents rare earth metals and TM represents transition metals.

RE₂TM₁₇ type magnets were started from the investigation of R₂(Co, Fe)₁₇ alloy by A. E. Ray and K. J. Strnat in 1972. However, numerous attempts to develop high _{I}H_{C} in these stoichiometric 2:17 alloys were generally unsuccessful and attention was then focused on Sm(Co_{0.85}Cu_{0.15})_{6.8} (Nagel et al., 1975) and Sm(Co_{0.85}Fe_{0.05}Cu_{0.10})_{0.85} (Tawara et al., 1976) with Br=10-11 kG; H₄=4-6 kOe and (BH)ₘₐₓ=26MGOe. Sm(CO_{0.68}Fe_{0.28}Cu_{0.1 Zr}_{0.01})_{7.4} with 30 MGOe was achieved in 1977 (Ojima et al., 1977). Research and development in the 1970s resulted in Re₂TM₁₇ type magnets with high energy product, where RE represents rare earth metals, such as Sm, Pr, Gd, Ho, Er, Ce, Y, Nd, and TM represents several transition metals such as Co, Fe, Cu, Zr, Hf, Ti, Mn, Nb, Mo, W, and mixtures thereof. Particularly preferred high performance magnets for the applications noted above are RE=Sm, Gd, Dy and TM=Co, Fe, Cu, and Zr, having the crystal structure of Sm₂Co₁₇. Most RE-TM magnets can be used at 250° C., and some of these magnets can perform well up to 330° C.

These magnets are described and claimed in U.S. Pat. Nos: 4,210,471; 4,213,803; 4,284,440; 4,289,549; 4,497,672; 4,536,233; 4,565,587; 4,746,378, and 5,781,843. See also U.S. Pat. Nos. 3,748,193; 3,947,295; 3,970,484; 3,977,917; 4,172,717; 4,211,585; 4,221, 613; 4,375,996; 4,382,061 and 4,578,125.

Related relevant publications include:

A. E. Ray and K. J. Strnat, IEEE Trans. Magn., Mag-8, 518, 1972.

Nagel, Perry and Menth, IEEE Trans. Magn. Mag-11, 1423, 1975.

Tawara and Strnat, “Rare earth Cobalt permanent magnets near the 2:17 composition”, IEEE Trans. Magn. Mag-12, 954, 1976.

Ojima, Tomizawa, Yoneyama, and Hori, “Magnetic properties of a new type of rare earth magnets Sm₂(CO,Cu,Fe,M)₁₇”, IEEE Trans. Magn. Mag-13, 1317, 1977.

A. E. Ray, “The development of high energy product permanent magnets from 2:17 RE-TM alloys”, IEEE Trans. Magn., Mag-28, 1615, (1984).

Marlin S. Walmer, “A comparison of temperature compensation in SmCo₅ and RE₂TM₁₇ as measured in a permeameter, a traveling wave tube and an inertial device over the temperature range of −60° to 200° C.”, Proceedings of the 9th International Workshop on rare earth magnets and their applications, Bad Soden, Germany, 131-140 (1987).

H. F. Mildrum and K. D. Wong, “Stability and temperature cycling behavior of RE-Co magnets”, Proceedings of the 9th International

Workshop on rare earth magnets and their applications, Bad Soden, Germany, 35-54 (1987).

J. Fidler, et al., “Analytical Electron microscope study of high and low coercivity SmCo 2:17 magnets”, Mat. Res. Soc. Sym. Proc. 96, 1987.

Popov et al., “Inference of copper concentration and the magnetic properties and structure of alloys”, Phys. Met. Metall., 60 (2), 18-27, (1990).

A. E. Ray and S. Liu, “Recent progress in 2:17 type permanent magnets”, J. Material Engineering and Performance, 1, 183-192 (1992).

Work continued on RE-TM magnets for use at temperatures above 300° C. post-1994. References related to these high temperature RE-TM magnets are listed below:

Marlin S. Walmer and Michael H. Walmer, “Knee formation of high Co content 2:17 magnets for MMC high temperature applications”, Electron Energy Corporation internal report, May, 1995.

S. Liu and E. P. Hoffman, “Application-oriented characterization of Sm₂(Co,Fe,Cu,Zr)₁₇ permanent magnets,”IEEE Trans. Magn., 32, 5091, (1996).

B. M. Ma, Y. L. Liang, J. Patel, D. Scott, and C. O. Bounds, “The effect of Fe content on the temperature dependent magnetic properties of Sm(Co,Fe,Cu,Zr)_{z} and SmCo₅ sintered magnets at 450° C.,” IEEE Trans. Magn., 32, 4377 (1996).

S. Liu, G. P. Hoffman, and J. R. Brown, “Long-term aging of Sm₂(Co,Fe,Cu,Zr)₁₇ permanent magnets at 300° and 400° C.,” IEEE Trans. Magn., 33, 3859 (1997).

A. S. Kim, J. Appl. Phys., 81, 5609 (1997).

C. H. Chen, M. S. Walmer, M. H. Walmer, S. Liu, E. Kuhl, G. Simon, “Sm₂(Co,Fe,Cu,Zr)₁₇ magnets for use at temperature >400° C., J. Appl. Phy., 83 (11), 6706 (1998).

A. S. Kim, “High temperature stability of SmTM magnets,” J. Appl. Phys., 83 (11), 6715 (1998).

M. S. Walmer, C. H. Chen, M. H. Walmer, S. Liu, G. E. Kuhl, G. K. Simon, “Use of heavy rare earth elements Gd in RECo₅ and RE₂TM₁₇ magnets for high temperature applications,” Proc. 15th Int. Workshop on Rare Earth Permanent Magnets and Their Applications, p. 689, (1998).

Christina H. Chen, Marlin S. Walmer, Michael H. Walmer, Wai Gong, and Bao-Min Ma, “The relationship of thermal expansion to magnetocrystalline anisotropy, spontaneous magnetization for permanent magnets”, J. Appl. Phys., 65(8), 5669 (1999).

J. F. Liu, Y. Zhang, D. Dimitar, and G. C. Hadjipanayis, “Microstructure and high temperature magnetic properties of Sm(Co,Cu,Fe,Zr)_{z} (x-6.7-9.1) permanent magnets”, J. Appl. Phys., 85(5), 2800 (1999).

J. F. Liu, Y. Zhang, Y. Ding, D. Dimitrov and G. C. Hadjipanayis, “New rare earth permanent magnet with a coercivity of 10 kOe at 773 K”, J. Applied. Phys., 85, 5660 (1999).

J. F. Liu, Y. Ding, D. Dimitrov and G. C. Hadjipanayis, “Effect of Fe on the high magnetic properties and microstructure of Sm(CoFeCuZr)_{z} permanent magnets”, J. Appl. Phys., 85, 1670 (1999).

J. F. Liu and G. Hadjipanayis, “Demagnetization curves and domain wall pinning sites in SmCo 2:17 magnets”, J. Magn. Magn. Mater., 195, 620 (1999).

J. F. Liu, Y. Zhang and G. Hadjipanayis, “High temperature magnetic properties and microstructure analysis of SmCo 2:17 commercial magnets”,J. Magn. Magn. Mater., 202, 69 (1999).

J. F. Liu, T. Chui, D. Dimitrov and G. C. Hadjipanayis, “Abnormal temperature dependence of intrinsic coercivity of Sm(CoFeCuZr)_{z} powder materials”, App. Phys. Lett. 73, 3007 (1998).

C. H. Chen, J. F. Liu, C. Ni, G. Hadjipanayis and A. Kim, “Magnetic and structure properties of commercial Sm₂(Co,Fe,Cu,Zr)₁₇-based magnets”, J. Appl. Phys., 83, 7139 (1998).

J. F. Liu, Y. Zhang, Y. Ding, D. Dimitrov and G. Hadjihanayis, “Rare earth permanent magnets for high temperature applications” (invited), in Rare-Earth Magnets and Their Applications, edited by L. Schultz and K.-H. Muller, Volume 2, pp. 607-622 (Proceedings of the 15th International Workshop on Rare Earth Magnets and Their Applications, Aug. 30 Sep. 3, 1998, Dresden, Germany).

J. F. Liu, Y. Zhang, Y. Ding, D. Dimitrov and G. C. Hadjipanayis, “Rare earth magnets for high temperature power applications”, Naval Symposium on Electric Machines, Oct. 26-29 1998, Annapolis, Maryland, pp. 171.

Sam Liu, Jin Yang, George Doyle, G. Edward Kuhl, Christina Chen, Marlin Walmer, Michael Walmer, and Gerard Simon, “New sintered high temperature Sm—Co based permanent magnet materials”, IEEE Trans. Magn. 35, 3325 (1999).

Sam Liu and G. Edward Kuhl, “Temperature coefficients of Rare earth permanent magnets”, IEEE Trans. Magn. 35, 3371 (1999).

Christina H. Chen, Marlin S. Walmer, Michael H. Walmer, Sam Liu, E. Kuhl, Geared K. Simon, “New Sm-TM magnetic materials for application up to 550°, 1999 Spring meeting, MRS Symposia Proceedings, to be published, (1999).

Christina H. Chen, Marlin S. Walmer, Michael H. Walmer, Jinfang Liu, Sam Liu, E. G. Kuhl, “Magnetic pinning strength for the new Sm-TM magnetic materials for use up to 550° C.,” 44th MMM conference in 1999, to be published in J. Appl. Phys., April, (2000).

Sam Liu, Jin Yang, George Doyle, Gregory Potts, and G. Edward Kuhl, C. H. Chen, M. S. Walmer, M. H. Walmer, “Abnormal temperature dependence of intrinsic coercivity in sintered Sm—Co based permanent magnets,” 44th MMM conference in 1999, to be published in J. Appl. Phys., April, (2000).

Marlin S. Walmer, Christina H. Chen, Michael H. Walmer, Sam Liu, E. G. Kuhl, “Thermal stability at 300-5500 for a new series of Sm₂TM₁₇ materials with maximum use temperature up to 550° C.,” Intermag 2000, to be published in IEEE Trans. Mag. (2000).

Sam Liu, Gregory Potts, George Doyle, Jin Yang, and G. Edward Kuhl, C. H. Chen, M. S. Walmer, M. H. Walmer, “Effect of z value on high temperature performance of Sm(Co,Fe,Cu,Zr)_{z} with z=6.5-7.3,” Intermag 2000, to be published in IEEE Trans. Mag. (2000).

Permanent magnets play a vital role in modern society as components in a wide range of devices utilized by many industries and consumers. In 1995, the world production of permanent magnets was estimated to be valued at about $3.6 billion and growing at an annual rate of about 12%. Bonded permanent magnets are now the fastest growing segment of this market. Bonded magnet technology enables a wide variety of magnetic particulates to be combined with various binders to produce permanent bonded magnets which utilize several processing options with essentially no limitations on shape or design.

The level of binder added to the magnetic particulate preferably has minimal interference with the magnetic properties including maximum energy product. Historically, bonded magnets produced using organic binders within the range of about 1 and about 4 wt. % have a void ratio (ratio of void volume to total volume) of no more than about 2 vol. %. See U.S. Pat. Nos. 5,888,417; 4,289,549; 5,888,416; Japanese Patent Applications No. 79332/78; 80746/77. See also U.S. Pat. Nos. 3,982,971; 4,000,982; 4,022,701; 4,081,297; 4,089, 995; 4,111,823; 4,121,952; 4,131,495; 4,135,853; 4,192,696; 4,200,547; and European Patent Application 97926267.2; 4,762,754; 4,717,627; and SBIR Contract DAAG55-97-C-0039 Report of May 15 1998. See also: U.S. Pat. Nos. 3,600,748; 4,536,233; 4,931,092; 5,376,291; 5,409,624; 5,405,574; 5,611,230; 5,647,886; 5,689,797 and 5,772,796.

For improved high temperature performance, mechanical strength, energy density; and for reduced void ratio; bonded permanent magnets require superior energy density, as well as higher temperature performing binders. These cannot be produced with the conventional manufacturing methods such as referenced above, i.e.,

1. compression molding,

2. Injection molding,

3. Extrusion molding, and

4. Calendering.

Compression molding is generally a method wherein a magnet composition comprising a magnetic particulate and a thermosetting resin is filled into a mold in a press at room temperature and compacted under pressures of up to about 70 tons/square inch. The compressed mixture is heated to cure the resin, thereby molding a bonded magnet. In the case of the compression molding method, since the binder content of the bonded magnet is lower than that for the other manufacturing methods, the freedom of shape in molding a bonded magnet is limited although the magnetic properties of the resultant bonded magnet are superior.

Injection molding is a method wherein a magnet composition comprising a magnet particulate and a resin component is heat-melted to prepare a melt having sufficient fluidity which is then injected into a mold where the melt is molded into a desired shape. In the case of the injection molding, in order to impart sufficient fluidity to the magnet composition, the resin content of the magnet composition is higher than that for the compression molding, resulting in lowered magnetic properties. The freedom in molding, however, is higher than that for the compression molding.

Extrusion molding is a method wherein a magnet composition comprising a magnet particulate and a resin component is heat-melted to prepare a melt having sufficient fluidity which is then formed into a shape in a die and set by cooling, thereby providing a product having a desired shape. In the extrusion, like the injection, the resin content needs to be high enough to impart fluidity to the magnet composition. This method is preferred for manufacturing thin-walled and long magnets.

Among the above methods, injection molding and extrusion generally use a thermoplastic resin. These are disclosed in Japanese Patent Laid-Open Nos. 123702/1987; 152107/1987; 194503/1985 and 211908/1985.

However, the conventional rare-earth bonded magnet composition comprising a rare-earth magnet particulate and a thermoplastic resin, used in the prior art methods, particularly in injection molding and extrusion molding, has the following problems. Specifically, since the rare-earth magnet particulate comprises a transition metal element, such as Fe or Co, when it is mixed and kneaded with a thermoplastic resin to prepare a composition which is then molded, the transition metal element catalytically generally reacts with the resin component causing an increase in molecular weight of the resin component, which results in a change in the properties of the composition, such as an increase in melt viscosity. This suggests a lowering in heat stability of the rare-earth bonded magnet composition. The above phenomenon is partly described in the Journal of the Magnetics Society of Japan, Vol. 16, No. 2, 135-138 (1992), indicating that a composition comprising an Nd-Fe-B-based magnet powder and a polyamide resin, due to the influence of temperature and shear stress, undergoes changes in properties, particularly viscosity. The higher the content of the rare-earth magnet particulate in the composition and the larger the specific surface area of the rare-earth magnetic particulate, the higher the above tendency. The above raises problems in producing stable rare-earth bonded magnets due to binder deterioration during molding, which adversely effects the magnetic properties of the molded bonded magnet.

Calendering is forming of a continuous strip by processing of the material between rollers. The strip may be up to several hundred feet long. Magnet powders are mostly ferrite, though some neo and ferrite/neo hybrids are available.

For the rare-earth, bonded magnet composition, the relationship between the properties of the composition and moldability has been discussed in Japanese Patent Laid-Open No. 162301/1989, which discloses a method wherein the viscosity of a molding composition is specified. In this method, however, the viscosity is specified in relation to the magnetic field for alignment. Further, the resin used is a thermosetting resin, and there is no clear description on the properties, involved in the moldability of a magnet composition using a thermoplastic resin. Furthermore, no particular attention is paid to a change in properties of the composition during moldings. In actual molding, a change in properties, as described above, occurs in the course of feed of the composition into a mold of the molding machine, which makes it difficult to conduct molding. In the case of injection molding, a sprue and a runner are generated due to the nature of the molding method and should be recycled. The resultant change in properties of the composition renders the recycling difficult, unfavorably increasing the loss of material. This incurs an increase in cost of the rare-earth bonded magnet. In the case of extrusion, unlike injection molding, there is little or no need of recycling. Since, however, the operation is carried out in a continuous manner, holding the composition in an extruder or a die often renders the molding unacceptable. Further, the deterioration of the composition causes a load to be applied to the machine, which often results in failure of the machine and damage to a screw and a die and a nozzle and the like of the injection molding machine.

For the magnet composition used in extrusion, Japanese Patent Laid-Open No. 264601/1989, the addition of a lubricant is disclosed. Japanese Patent Laid-Open No. 289807/1988 and 162301/1989 disclose a magnet composition using a thermoplastic resin, and Japanese Patent Application No. 270884/1991 discloses a magnet composition having a specified viscosity.

Further, as described above, the rare-earth magnetic particulate is sufficiently active enough to deteriorate the resin component during molding, causing the resultant magnet molding to rust when it is allowed to stand in an oxygenated environment (e.g., air).

Among the above methods for producing a rare-earth bonded magnet, compression molding can produce magnets having the highest performance. Since, however, a thermosetting resin is employed as the resin, the step of heat- curing the resin must be additionally provided after the molding, so that the properties of the resin at the time of heat setting should be taken into consideration. For this reason, the resin cannot be selected based on the moldability alone, and consequently the type and amount of the resin and the molding conditions cannot be determined from the viewpoint of the moldability alone. Furthermore, since the resin used is a thermosetting resin, defective molded materials cannot be recycled.

Other methods of compacting magnet metal particulate are reported in the literature, e.g.,

One method employed is that of melt textured growth of polycrystalline material. This method is discussed in a paper included in Volume 37, No. 13, May 1, 1988, Physical Review B, S. Gin, et. al., entitled, Melt-Textured Growth of Polycrystalline. This method consists of heating a bulk specimen of the high temperature material in a furnace to temperatures at which partial melting occurs. A temperature gradient is maintained in the furnace, and the superconductor is melted and recrystallized as the specimen is passed through the hot zone. Highly textured material is produced through this method and at present, is shown to yield high critical current density values. This method is generally limited to the processing of small length samples.

Another method is that of placing particulate (powder) in a tube. This “powder in tube” method is discussed in a paper in Applied Physics Letters, page 2441, 1989, prepared by K. Heins, et. al., entitled, High-Field Critical Current Densities. In the “powder in tube” method, mechanical deformation is used to align plate-like particles of bismuth based superconductors. The powder is loaded into a tube of silver material and the assembly is compacted by swaging, drawing or rolling. A silver sheath provides a path to shunt currents across any defects. The material is subsequently heat treated to obtain the optimum superconductor characteristics.

However, as a result of the nature of varied mechanical operations involved in the two methods discussed above, consistently reproducing the many processing steps repeatedly during fabrication of long lengths of wires and tapes remains unsatisfactory.

Another method of compaction is that of hot extrusion. This method is discussed in an article entitled Hot Extrusion of High-temperature Superconducting Oxides by Uthamalingam Balachandran, et. al., American Ceramic Bulletin, May 1991, page 813.

Another method is discussed in U.S. Pat. No. 5,004,722 entitled “Method of Making Superconductor Wires by Hot Isostatic Pressing After Bending.”

Another compaction technique which has been employed pertains to a shock method. This method is discussed in an article entitled, Crystallographically oriented superconducting B₁₂St₂CaCu₂O₈ by shock compaction of prealigned powder, by C. L. Seaman, et. al., in Applied Physics Letters dated Jul. 2, 1990, Volume 57, page 93.

Another method of compaction is that known as an explosive method, discussed in an article entitled, Metal Matrix High-Temperature Superconductor, by L. E. Murr, et. al., of Advanced Materials and Processes Inc. in Metal Progress, October 1987, page 37.

These methods are limited in value as they are generally applicable only to production of small body sizes.

The application of large uniaxial static pressures at elevated temperatures is discussed in an article entitled, Densification of YBa₂Cu₂O₇₋₈ by uniaxial pressure sintering, by S. L. Town, et. al., in Cryogenics, May 1990, Volume 30.

The use of electromagnetic forming for the purpose of attachment is discussed in a paper entitled, Electromagnetic Forming, by J. Bennett and M. Plum, published in Pulse Power Lecture Series, Lecture No. 36.

High temperature, stable, bonded permanent magnets exhibiting improved density with a minimum of voids, having: (a) a (BH)ₘₐₓ approaching 100% of theoretical, (b) a void ratio approaching 0%, and (c) use temperatures up to 550° C.

The prior art fails to teach or suggest means for efficiently producing bonded permanent magnets with increased (BH)ₘₐₓ and higher use temperatures.

### OBJECTS OF THE INVENTION

A primary object of the invention is to provide a dynamic magnetic compaction (DMC) method for producing stable, denser, bonded permanent magnets where the binder is inorganic or organic, having a minimum void ratio and up to about 40% increase in (BH)ₘₐₓ over that achieved with traditional mechanical compaction.

Yet another object of the invention is to provide an organic bonded magnet manufactured by dynamic-magnetic-compaction (DMC) wherein the average particle diameter of the magnetic powder is from between about 10 and about 70 microns, the level of the organic binder is from between about 0.1 and about 2.0 wt. %.

Another object of the present invention is to provide a DMC method to produce inorganic bonded magnets having superior magnetic properties, dimensional precision and stability at elevated use temperatures.

Another object of the invention is to provide a DMC method to produce metallic bonded magnets with superior magnetic properties, dimensional precision and superior heat resistance after long term exposure at high temperature.

Still another object of the invention is to provide a DMC means for producing bonded magnets with improved strength and resistance to breakage and shock.

Yet another object of the invention is to provide a DMC method for manufacturing bonded magnets with increased magnet alloy particulate density, low void ratio and high mechanical strength.

Still another object of the invention is to provide a method for producing rare-earth bonded magnets with decreased binder levels, yet having high density and strength, using DMC processing.

And another object of the invention is to provide a method for producing rare earth bonded permanent magnets containing from between about 0.1% and about 2% by weight organic binder using dynamic magnetic compaction to produce an isotropic Nd₂Fe₁₄B bonded magnet with maximum energy product ranging from between about 10 MGOe and about 15 MGOe, wherein DMC is employed.

A further object of the invention is to provide a means for producing a wide range of high energy product, high use temperature RE(Co_{w}FeᵥCuₓTM_{y})_{z}-type bonded magnets by dynamic magnetic compaction (DMC).

Another object of the invention is to provide dynamic electromagnetic compacted rare-earth bonded magnets using a wide range of inorganic and organic binders.

Yet another object of the invention is to provide a means for producing high density, rare-earth, electromagnetic compaction, bonded magnets comprising RE(Co_{w}FeᵥCuₓTM_{y})_{z}-type alloys and mixed with: (a) high temperature stable organic binders and having use temperatures up to about 250° C. and (b) with metal binders having a melting point above 400° C.

Still another object of the invention is to provide suitable microstructure for DMC bonded RE(Co_{w}FeᵥCuₓTM_{y})_{z}-type magnets.

Yet another object of the invention is to provide a suitable particle size and particle size distribution of RE(Co_{w}FeᵥCuₓTM_{y})_{z}-type particulates for dynamic magnetic compaction.

Still another object of the invention is to provide a process for producing high density, high maximum energy product RE(Co_{w}FeᵥCuₓTM_{y})_{z}-type bonded magnets.

A further object of the invention is to provide magnetically coupled alloys for dynamic electromagnetic compaction.

Another object of the invention is to provide dynamic magnetic compaction bonded magnets comprising two or more alloy particulates having different coercivity and residual induction values.

Another object of the invention is to provide a DMC process for producing high energy product (BH)ₘₐₓ bonded Nd₂Fe₁₄B isotropic magnets with superior density.

A further object of the invention is to provide DMC compatible lubricants, coupling agents, antioxidants and binders for dynamic magnetic compacted rare-earth bonded magnets.

Still another object of the invention is to provide a method for producing bonded magnets having controlled release of silver ions sufficient to create an “antimicrobial flux zone” around said magnet.

Yet another object of the invention is to provide a method for producing enhanced silver ion generating, bonded permanent magnets suitable for various biomedical and biofilm controlling applications.

Another object of the invention is to provide a DMC process for producing high density, high-energy product (BH)ₘₐₓ anisotropic bonded magnets.

### BRIEF DESCRIPTION OF THE DRAWINGS

FIG. 1 is a perspective diagrammatic view illustrating a structure and a method for dynamic magnetic compaction of mixtures of permanent magnet particulates and various binders into high density bonded magnets.

FIGS. 2, 2A and 2B are perspective and cross-sectional views of Sm(CoFeCuZr)_{z} as-cast ingot grains which when particularized are suitable for use in DMC bonded permanent magnets.

FIGS. 3, 6 and 7 set out demagnetization curves for various DMC bonded magnets of the invention.

FIG. 4 sets forth maximum use temperature vs. Co content curve, for DMC metal bonded magnets of the invention

FIG. 5 describes temperature dependence of _{I}H_{C} of DMC metal bonded SmCo DMC bonded magnets of the invention.

### SUMMARY OF THE INVENTION

The present invention provides a method of manufacturing a class of density enhanced, bonded permanent magnets having the following properties:

a. maximum energy product (BH)ₘₐₓ up to 40% greater than that of traditional, mechanical, compacted, bonded permanent magnets,

b. (BH)ₘₐₓ up to 99% of theoretical,

c. a void ratio approaching 0 volume %, and

d. a use temperature from room temperature up to about 550° C., said method comprising the step of compacting a mixture of permanent magnet particulates and a binder using pulsed electromagnetic forces, where each pulse has a pulse time less than the thermal time constant of the permanent magnet particulate, and wherein said compaction is achieved without adversely affecting the binder or the structure of the permanent magnet particulates.

Preferably, the method of the present invention comprises the following steps:

i. mixing permanent magnet particulates with a binder;

ii. subjecting said mixture to an initial compression forming force, forming a first compressed mixture; and

iii. subjecting said first compressed mixture to pulsed dynamic magnetic compaction, wherein the compaction pulse time is less than the thermal time constant of said magnet particulate.

DMC achieves compaction of bonded magnets by means of at least one electromagnetic pulse, where the duration of the pulse is less than the thermal time constant of the magnet particulate. The resultant transverse electromagnetic shock wave compacts and bonds the magnetic particulate/binder mixture. The preferred magnitude of the pulsed shockwave is so chosen that it generates bonding and compaction of the magnetic particulate/binder mixture thereby maximizing density without altering the binder and thereby allowing for elevated use temperatures.

Pressures which are applied by the methods and/or structures of this invention may be applied to particulate mixtures of permanent magnet particulates and binder powders therefore upon which no prior compaction pressure has been applied. Where a mixture of permanent magnet particulate and binder powder has been previously compacted by mechanical or other means, additional application of compaction pressure by the DMC process of the present invention can be achieved as a restrike application of the DMC process.

The method of the present invention provides a new class of bonded, permanent magnets. Preferably, these magnets are manufactured using a pulsed Dynamic Magnetic Compaction (DMC) process wherein said bonded magnets have: (a) superior (BH)ₘₐₓ (up to 99% of theoretical and up to 40% greater than commercial counterparts), (b) a void ratio approaching 0%, (c) a structure that is not altered during compaction, (d) a binder that is not altered during compaction and (e) elevated use temperatures.

In compacted bonded permanent magnets of the invention, the permanent magnet particles have a thermal time constant that is related to:

the size of the particle of a given material,

the thermal conductivity of the particle,

the heat capacity of the particle and

the density of the particle. This relationship is represented by the following equation:

T=DC/KR²

in which T represents the thermal time constant of the particle, D represents the density of the particle, C represents the capacity of the particle, K represents the thermal conductivity of the particle and R represents the size of the particle.

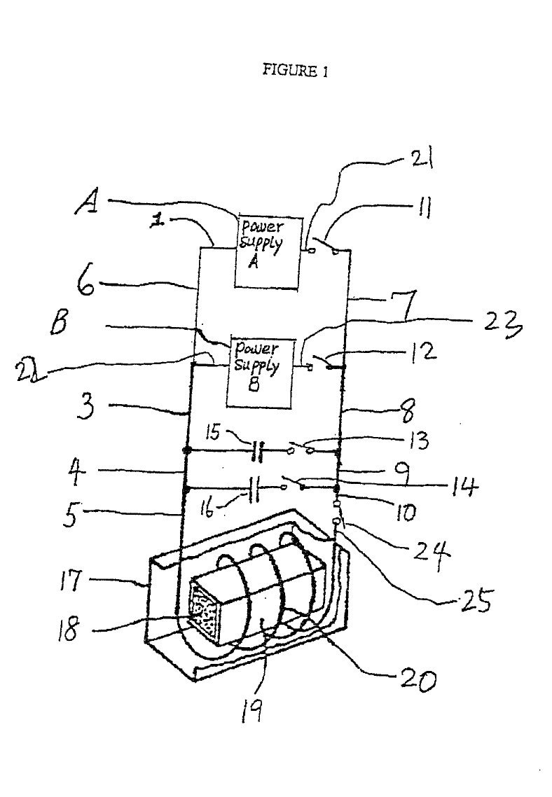

When the pulse time of applied magnetic pressure is less than the thermal time constant of the permanent magnet particle, greater compressibility of the compressed particle is obtained. The density of bonded permanent magnets can be increased by a predetermined number of applications of electromagnetic pulses of short time duration, each of the pulses having a pulse time which is less than the thermal time constant of the particle. Two general types of pulses are employed in the present invention, i.e., orienting pulses and compaction pulses. These are detailed in the discussion of FIG. 1 below.

### DETAILED DESCRIPTION OF THE PREFERRED EMBODIMENTS

In the preferred DMC process for manufacturing high density bonded permanent magnets a mixture of permanent magnet particulate and binder particulate is placed within an electrically conductive means. A solenoid or coil encompasses this electrically conductive means. An electrical charge flows through the solenoid creating pressures upon the electrically conductive means compressing the means and reducing the transverse dimension thereof. The permanent magnet powder/binder powder mixture is compacted by one or more electromagnetic pulse(s).

When high magnitudes of electrical current are passed through the solenoid, corresponding high pressures are applied to the electrically conductive container, which is reduced in transverse dimensions. This causes the permanent magnet particulate and binder mixture within the electrically conductive container to be compacted into a bonded permanent magnet approaching 100% of the theoretical density with minimum void ratio and with minimum deterioration of the binder.

FIG. 1 illustrates a preferred structure and a method for DMC of isotropic and anisotropic bonded magnets wherein: A and B represent power supplies connected to conductors 1 and 21 and conductors 22 and 23, respectively. It is understood power supplies A and B can be integrated. Preferably, they are separate power supply systems with the proviso that energy from power supply B is greater than that from supply A.

Conductor 21, via switch 11 is connected to conductor 7, while conductor 23 via switch 12 is connected to conductors 7 and 8. Conductors 3 and 4 and conductors 8 and 9 are connected through capacitor 15 and switch 13. Similarly, conductors 4 and 5 and conductors 9 and 10 are connected through capacitor 16 and switch 14. Conductors 10 and 25 are connected through switch 24.

The conductors 5 and 25 are connected to solenoid or coil 20 which encompasses electrically conductive container 19. The shape and size of the desired DMC bonded permanent magnet determines the size and shape of said electrically conductive container 19. Container 19 may be of any suitable electrically conductive material, such as silver or copper. Coil 20 accommodates the size of container 19. Container 19 holds mixture 18, which represents a mixture of permanent magnet particulate and binder as described below. The mixture fills container 19 and is firmly positioned there within.

The DMC process for isotropic bonded magnets comprises closing switches 23 and 13 with switches 11 and 14 open. Capacitor 15 is charged to capacity by power supply B, after which switch 12 is opened and switch 24 is closed, thereby driving a large quantity of electrical current from capacitor 15 through coil 20. This flow of electrical current applies electromagnetic pressure upon electrically conductive container 19.

This electromagnetic pressure on conductive container 19 reduces transverse dimensions of said container and simultaneously compacts mixture 18 to a dense, DMC compacted, bonded permanent magnet. Depending on the nature of the binder, the resultant magnet can be: (a) cured at appropriate temperatures for thermosetting resin curing, (b) heated to a temperature above the melting point of the thermoplastic binder, provided an inert atmosphere, such as argon or nitrogen is employed, and (c) sintered at a temperature below 400° C. where the binder is inorganic.

The current flowing through coil 20 may be on the order of about 100,000 amperes at a voltage of about 4,000 volts.

The DMC process for anisotropic bonded permanent magnets comprises opening switches 12 and 13, while switches 11 and 14 are closed. Capacitor 16 is charged by power supply A, after which switch 11 is opened and switch 24 is closed, thereby driving electrical current at magnetic alignment levels from capacitor 16 to coil 20. This flow of this lower level of electrical current applies magnetic alignment pressure to container 19 without altering the dimensions of container 19, while magnetically aligning mixture 18. Alignment magnetic fields of at least 30 to about 45 KOₑ are preferred.

After alignment of mixture 18 is achieved, switches 21, 24 and 14 are opened while switches 12 and 13 are closed. Capacitor 15 is thereby charged by power supply B, after which switch 12 is opened and switch 24 is closed driving a large quantity of current from capacitor 15 through coil 20.

This flow of current through coil 20 applies compaction pressure to container 19, reducing the transverse dimensions of container 19, thereby compacting mixture 18 into a high density, bonded permanent magnet without adversity affecting the binder in Mixture 18. The resultant magnet is then cured, heat-treated or sintered at temperatures appropriate for thermosetting thermoplastic or inorganic binders. Upon cooling to room temperature, DMC bonded, anisotropic, permanent magnets are manufactured.

It is understood, of course, that other magnitudes of current may be employed as found to be suitable in accordance with the size and physical characteristics of the electrically conductive container 19 and the physical characteristics and volume of the 18. It is also to be understood that when the mixture 18 has good electrically conductive properties the container 19 may not need to be electrically conductive for compaction of the powder-like material in accordance with the method of this invention.

Due to the fact that the coil 20 tends to expand radially as current flows therethrough, suitable means are employed to restrain the coil 20 against lateral expansion as current flows therethrough. For example, as shown, container 19 and coil 20 are encompassed by rigid wall 17, which restrains the coil 20 against expansion as current flows therethrough.

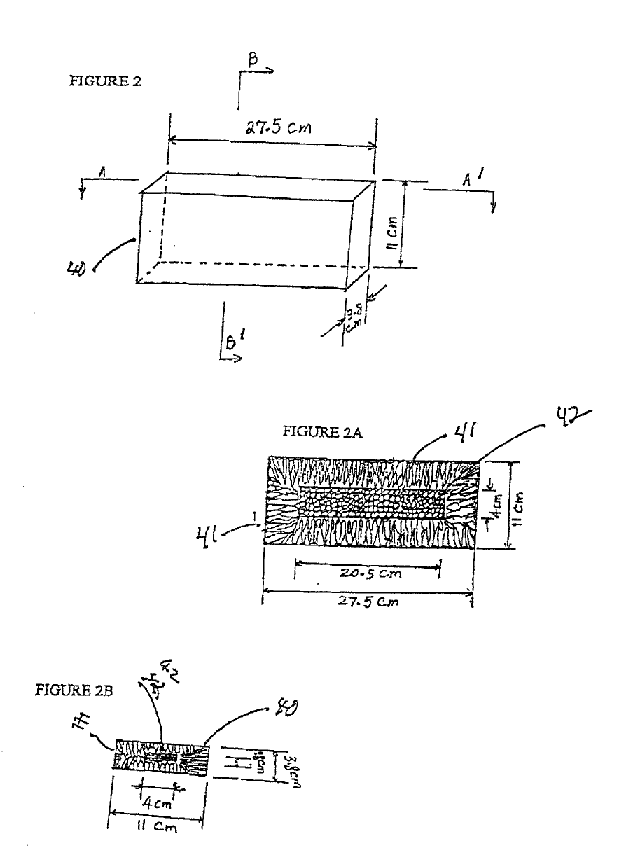

FIGS. 2, 2A and 2B illustrate a Sm(Co,Cu,Fe,Zr)_{z} perspective of a permanent magnet ingot and lateral and linear cross-sectional views thereof taken from line A-A′ and B-B′, respectively, and illustrate columnar grains of a Sm(Co_{w}FeᵥCuₓZr_{y})_{z}-type alloy.

The cast ingot 40 illustrated is 27.5 cm in length, 11 cm high and 3.8 cm wide and has a volume of 1149.5 cm³. The volume of columnar grains shown is 1083.9 cm³, while the volume of equiaxed grains, 42 is 65.6 cm³. The percentage of columnar grains, 41, in ingot 40 is 94%. Preferably, ingots with more than 90% (in volume) columnar grains are milled into magnet particulate for use in the DMC bonded permanent magnets of the present invention. This is detailed further in the discussion of Example M10 below.

DMC bonded permanent magnets of the invention use pressure generated by pulsed magnetic fields. See U.S. Pat. No. 5,405,574, which is hereby incorporated herein by reference. This process enables ultra-fast compaction (milliseconds) of alloy/binder particulates at high energies and desirable temperatures while retaining grain size and type of the alloy and the properties of the binder. The process is non-contact, having wide tonability in the process parameters (pressure magnitude and duration, temperature and number of pulses) which can be precisely reproduced at a rapid rate. Using DMC, any size of magnetic powders and binders can be consolidated to near full density without altering the structure of the alloy, while also substantially avoiding degradation of the binder. This produces higher density bonded magnets of the invention.

The DMC process can be used to improve the density of a wide range of bonded magnets using various metal powders and a wide range of binding materials ranging from inorganics to organics as well as various mixtures thereof.

Depending on the nature of the particulates, both magnetically isotropic and anisotropic bonded magnets can be manufactured using the DMC process. See the discussion of FIG. 1, above. Isotropic bonded neodymium magnets are used in a wide range of applications including spindle and stepper motors used in the computer and consumer electronics industries. To achieve orienting of anisotropic magnet particles prior to compaction, a lower electromagnetic orienting pulse is applied to the particulate mix, followed by one or more “compaction” pulses as described in the discussion of FIG. 1.

A new class of RE(Co_{w}FeᵥCuₓTM_{y})_{z} rare earth magnets is described in copending Application Ser. No. 09/476,664, filed Jan. 3, 2000, the disclosure of which is hereby incorporated herein by reference. These permanent magnets have superior high temperature performance, i.e., use temperatures up to about 550° C. can be achieved with substantially linear demagnetization curves. This class of RE(Co_{w}FeᵥCuₓTM_{y})_{z} magnet particulates can be used in a wide range of DMC bonded magnets, provided inorganic binders stable at these elevated temperatures are used. Generally, these DMC bonded Sm(Co,Cu,Fe,Zr)_{z} magnets have use temperatures up to 550° C.

Heretofore, bonded magnets were limited to low temperature applications up to about 150° C. Moreover, RE(Co_{w}FeᵥCuₓTM_{y})_{z} permanent sintered magnets traditionally had use temperatures only up to about 330° C. Above this temperature, the demagnetization curves were not linear and were generally not suitable.

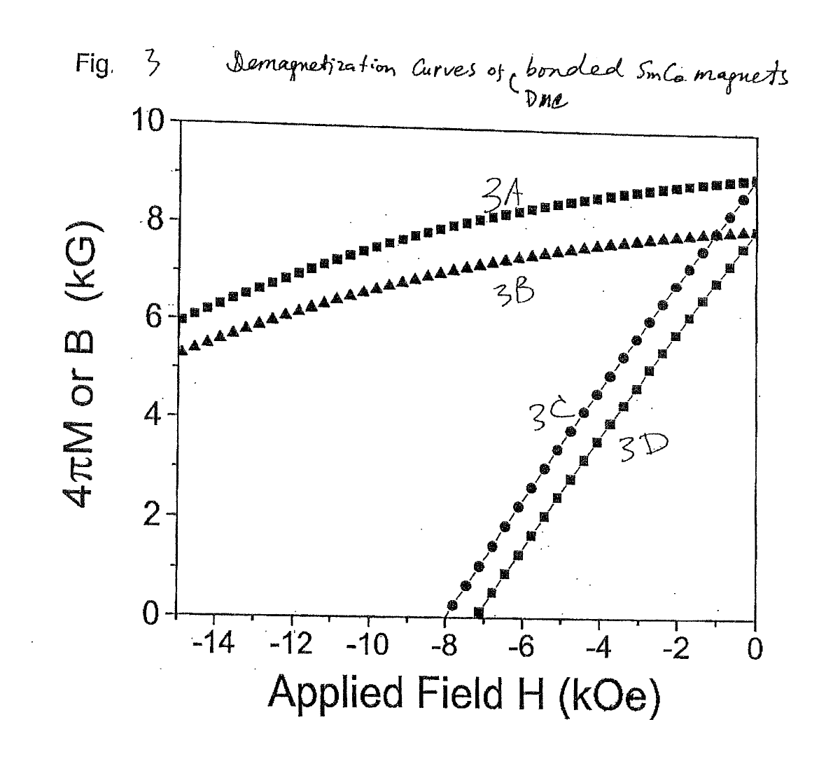

The present invention provides bonded permanent magnets containing inorganic binders used in conjunction with the referenced class of high temperature performing RE(Co_{w}FeᵥCuₓTM_{y})_{z} alloys where the binder and alloy are compacted with DMC. Surprisingly, the resulting higher density, bonded magnets (as shown in FIG. 3) have use temperatures up to about 550° C.

In a preferred embodiment of the invention, the permanent magnet particulate component of the DMC bonded magnets of the invention includes at least 90 volume percent of a samarium-transition metal alloy in a molar ratio of about 2 to 17. These preferred high temperature performing magnet particulates are represented by the general formula:

RE(Co_{w}FeᵥCuₓTM_{y})_{z}

where the sum of w, v, x, and y is 1, z is between about 5 and 8.5, RE is a rare earth element selected from the group consisting of Sm, Y, La, Ce, Pr, Nd, Gd, Tb, Dy, Ho, Er, and mixtures thereof, and TM is a transition metal selected from the group consisting of Zr, Hf, Ti, Mn, Cr, Nb, Mo, W, Ni, Ta, V and mixtures thereof. The class of DMC bonded, permanent magnets of the invention exhibit substantially linear extrinsic demagnetization curves at use temperatures approaching 550° C.

### COMPOSITE METAL-METAL PERMANENT MAGNETS

The term “metal-metal matrix composite” herein means a mixture of two independent and discrete metallic materials. One of the metallic materials referred to as the matrix is present as the continuous phase and provides the bonding for the composite. The other metallic material is considered the discontinuous phase and is present largely as particles surrounded by the matrix. This does not preclude the possibility of contacts between particles of the discontinuous phase. A metal-metal matrix composite is different from an alloy or a solid solution in that each metallic material in the composite retains its own chemical properties, crystalline structure, and microphysical properties. On a macroscopic scale, the composite has a new set of properties, which are a combination of the components in the composite.

The continuous or matrix phase of the bonded magnet is generally a metal softer than the discontinuous phase such as copper, nickel, or cobalt. While the amount present of the continuous phase in the permanent magnet is less than the discontinuous phase, the method of fabrication of the present invention preferably provides a continuous phase present around and between the magnetic material particles. The metals selected as the continuous phase are generally selected, for example, because of their ease of reduction from solution, their malleability, elevated temperature tolerance and susceptibility to DMC-type compaction.

Ease of reduction from solution is important because the simplest way of evenly and uniformly coating the outside of a large number of tiny particles at once is to disperse those particles in a fluid containing the coating. When the material is fully dispersed, all of the outside surface is in contact with the coating medium. If the coating is a metal, and the coating operation is to be carried out below the coating melting point, one practical approach is plating from a solution. To be successful, it is necessary to reduce the metal ion without using a system that corrodes the magnetic particulate. The choice of reductants, therefore, should be the materials which are either already in the system or reducing agents which are not reactive towards the magnetic material.

Malleability is important for developing a final bonded magnet. Heretofore, the desired forming method was pressing or rolling at ambient temperature. The composite parts were produced by pressing the hard grains, coated with soft metal, together until the coatings bonds with itself, and flows out from between close approach points of the particles to fill the interstitial voids.

Another way of making metal bonded magnets is simply blending the mixture of magnetic particles and metal-binders, and then pressing the blended mixture using a compression-molding machine. The average particle size of metal-binders is normally less than 5 microns, preferably less than 2 microns, more preferably less than 0.5 microns.

The homogeneous mixture can be pressed using a compression molding machine at room temperature or at elevated temperatures up to 400° C. Warm pressing gives better binding, high mechanical strength and higher density. When the pressing temperature is higher than 150°, protective atmosphere such as argon or nitrogen, is preferred.

In this invention, the homogeneous mixture is pressed by dynamic magnetic compaction (DMC). The metal bonded magnets made by dynamic magnetic compaction (DMC) give the highest mechanical strength and density and, therefore, the best magnetic performance.

The softer metal used may be any metal which is known to have good ductility and may include, for example, copper, cobalt, nickel, tin, lead, mercury, silver, gold, palladium, iridium, rhodium, rhenium, bismuth, and platinum. Copper, cobalt, and nickel are the preferred softer metals used in the present invention because of their abundance and availability as highly pure compounds and because of their corrosion resistance. Tin and silver are the next preferred softer metals used in the present invention because of their availability. Tin has a lower melting point and silver compounds are generally less soluble. Silver ceramic combinations, such as silver zeolite, where the release of silver ions from the ceramic is controlled, have utility for various biomedical applications including invasive and noninvasive applications. DMC is particularly attractive for use with bonded magnets used to deliver antimicrobial properties, where the antimicrobial properties are protected and not adversely affected during bonded magnet formation.

The amount of softer metal bonded to the alloy particulates should be sufficient to physically hold the alloy particulates together and provide a strong part. The amount of softer metal used should, however, not be so much that the magnetic properties of the alloy are adversely affected such as adversely reducing magnetic strength. The amount of softer metal used may preferably range from about 4 to about 15 volume percent of the bonded magnet and more preferably from about 6 to about 10 volume percent.

The particles of the softer metal are preferably less than about 2 microns in size and more preferably less than about 0.5 microns in size. DMC bonded metal-metal matrix composite magnets offer an alternative to sintered rare earth magnets and to DMC organic, bonded, permanent magnets. DMC metal-metal matrix composite magnets, like organic-bonded magnets, are less expensive and less complicated to produce than sintered rare earth permanent magnets. One advantage of DMC bonded metal-metal matrix composite magnets over DMC organic-bonded magnets is temperature resistance. DMC organic-bonded magnets are limited to service temperatures which will not exceed the limits of what the organic-binder can withstand. The temperature limit for organic-bonded systems is either the softening point of the organic resin used or when oxygen diffusion becomes possible. Most resins with sufficient fluidity to be formed with a heavy loading of solids cannot be used in air at above 150° C. An epoxy resin, for example, at 150° C. allows oxygen permeation to the DMC bonded magnetic materials which hereafter begins to corrode and lose its magnetic properties.

In a DMC bonded metal-metal matrix composite magnet, the upper limit for service temperature is set by the magnetic alloy in the magnet. The present invention has developed a high temperature Sm(Co,Fe,Cu,Zr)_{z} alloy that can be used up to 550° C. Commercial Sm(Co,Fe,Cu,Zr)_{z} bonded magnets can only be used up to 180° C. The new DMC bonded high temperature Sm(Co,Fe,Cu,Zr)_{z} magnets of this invention will find more applications which require high performance temperatures above 300° C.

Another advantage of metal-metal matrix composite magnets over DMC organic-bonded magnets is in maximum achievable energy product. Yet another advantage of a metal-metal matrix composite magnet is its corrosion resistance to organic solvents and moisture. For example, over a lifespan of 10 or 20 years, a permanent magnet motor can have many opportunities for exposure to materials such as lubricants, lubricant carriers, grease solvents, and paint solvents. All of these materials have the potential to deteriorate the plastic in a resin-bonded magnet which can lead to failure. On the other hand, none of these materials will have any effect on a DMC bonded metal-metal matrix composite magnet.

A DMC bonded metal-metal matrix composite magnet has better moisture resistance than a sintered magnet because most of the outer surface of a metal-metal matrix composite magnet is, for example, either copper, cobalt, or nickel and none of these elements are oxidized by water. Thus, moisture alone will have little effect on the magnet. Any deterioration of a DMC metal- metal matrix composite magnet will be comparable to, or less than what would occur with a resin-bonded magnet.

DMC bonded metal-metal matrix composite magnets, however, are susceptible to attack by mineral acid or other electrolytes. Any Nd_{2 Fe}₁₄B, or RE(Co_{w}FeᵥCuₓTM_{y})_{z} DMC bonded magnet will be damaged by exposure to oxidizing acid such as HNO₃ or H₂SO₄. In contrast, corresponding DMC resin-bonded magnets will suffer the least amount of acid corrosion because, once the metal in the top layer is dissolved, the rate of attack will drop sharply. It is recognized, however, that any DMC bonded magnet may be protected by coating the final fabricated magnet or part with a corrosion resistant layer.

There is a growing interest in the magnet industry in producing metal-metal matrix composite magnets, as an alternative to sintered magnets and polymer-bonded magnets. It is known for example, as disclosed in Japanese Patent No. 62-137809, to produce a metal matrix-bonded neodymium-iron-boron alloy magnet by mixing a metal powder such as copper, aluminum, zinc or lead powder as a bond phase with a fine powder of the alloy magnetic material. RE(Co_{w}FeᵥCuₓTM_{y})_{z} metal matrix bonded magnets can similarly be produced. Those metal/magnetic material powder mixtures are compression molded and then sintered to form magnets of specified shapes. In this known process a layer of metal (bond phase) is not chemically deposited on the surface of the magnetic material to produce the bond, but the process simply involves physically mixing a magnetically inert metal powder and a magnetic metal powder. The resulting mixed powder is then sintered. A disadvantage of the above known process is that a maximum energy product of less than 6 MGOe is obtained for bonded NdFeB magnets. With respect to use of low-melting (i.e., <400° C.) metals such as lead, metal-metal matrix composite magnets may suffer loss of physical strength at high temperatures due to the low melting points of the metal binder.

The DMC method for the metal-metal bonded magnets of the present invention produces as strong magnets as possible. Although physical strength is a beneficial feature, the most important strength is the magnetic strength. Magnetic strength is defined as the energy product, (BH)ₘₐₓ, of the magnet, as determined by measuring its hysteresis loop. Generally, the DMC bonded isotropic NdFeB magnets of the invention have a maximum energy product (BH)ₘₐₓ from between about 10 MGOe and about 14 MGOe. The conventional process can only give maximum 10 MGOe.

The DMC bonded anisotropic NdFeB magnets of the invention have a maximum energy product (BH)ₘₐₓ from between about 15 MGOe and about 22 MGOe, comparing only up to 15 MGOe by the conventional process. The DMC bonded Sm(Co,Cu,Fe,Zr)_{z} magnets of the invention have various maximum energy product (BH)ₘₐₓ depending upon the use temperature. DMC bonded Sm(Co,Cu,Fe,Zr)_{z} magnets with use temperatures up to 550° C. have a maximum energy product (BH)ₘₐₓ9 MGOe. DMC bonded Sm(Co,Cu,Fe,Zr)_{z} magnets, with use temperatures up to 500° C., have a maximum energy product (BH)ₘₐₓ11 MGOe. DMC bonded Sm(Co,Cu,Fe,Zr)_{z} magnets, with use temperatures up to 400° C., have a maximum energy product (BH)ₘₐₓ14 MGOe. DMC bonded Sm(Co,Cu,Fe,Zr)_{z} magnets, with use temperatures up to 200° C., have a maximum energy product (BH)ₘₐₓ18-23 MGOe. Commercial bonded magnets can only be used up to 180° C. See also FIGS. 3 through 7.

For lower temperature applications, the DMC bonded permanent magnets of the invention comprise mixtures of various permanent magnet particulates with organic binders including thermoplastic and thermosetting resins. The void ratio of such traditional organic resin bonded magnets tends to be large in a case where a thermosetting resin is used as the binder resin, as compared to the case where a thermoplastic resin is used. Even in such a case, however, a thermosetting bonded magnet having a reduced void ratio can be manufactured by the dynamic magnetic compaction (DMC) process of the present invention.

Examples of thermoplastic resins suitable for the DMC bonding process include: polyamides such as nylon 6, nylon 66, nylon 612, nylon 11, nylon 12 and nylon 6-12; liquid crystal polymers such as aromatic polyester; polyphenylene oxide; polyphenylene sulfide; polyolefin such as polypropylene; modified polyolefins; polycarbonates; polymethyl methacrylate; polyethers; polyetherimides; polyacetals; and copolymers, mixtures and polymer alloys containing the above as the main ingredient. These resins may be used solely or in combination.

Among these resins, polyamides are preferably selected as a main ingredient since they achieve improved compatibility and have high mechanical strength, liquid crystal polymers and polyphenylene sulfides are also preferably selected as a main ingredient since they have a higher melting point and improved thermostability. Additionally, these thermoplastic resins have superior kneadability with magnetic powders.

There is advantageously a wider selection of thermoplastic resins for use in DMC bonding, including resins of various types and copolymerized resins. In other words, the thermoplastic resin to be used can be selected in accordance with the situational importance such as compactibility, thermostability and mechanical strength.

Among the thermoplastic resins disclosed above, those with superior wettability relative to the surface of the magnet powder are preferred to affect optimum coverage of the outer surface of the magnet powder and improved mechanical strength with DMC bonded permanent magnets of the invention.

With a view to further improving wettability to the magnet powder surface, fluidity and moldability, the average molecular weight (degree of polymerization) of the thermoplastic resin used in the present invention should preferably be within a range of from about 10,000 to 60,000 or more preferably from about 12,000 to 30,000.

The content of the thermoplastic resin in a DMC bonded magnet should be within a range of from about 0.5 to 5 wt. %, or preferably from about 0.5 to 2 wt. %. When adding an oxidation inhibitor described later, the content of the thermoplastic resin should preferably be within a range of from about 0.5 to 1.5 wt. %, or more preferably from about 0.7 to 1.2 wt. %. A lower content of the thermoplastic resin makes it difficult to get sufficient binding between the magnetic powder and thermoplastic binder, and leads to easier occurrence of contact between adjacent particles of magnet powder, thus preventing a magnet having a low vacancy ratio and a high mechanical strength from being obtained. A higher content of the thermoplastic resin results in poorer magnetic properties although the mechanical strength is satisfactory.

Examples of thermosetting resins useful in DMC bonded permanent magnets include: epoxy resins, phenol resins, urea resins, melamine resins, polyester (unsaturated polyester) resins, polyimide resins, silicone resins, and polyurethane resins. These resins may be used solely or in combination.

Among them, epoxy resins, phenol resins, polyimide resins and silicone resins are preferred, and epoxy resins are especially preferred, since they achieve markedly-improved compactibility and have high mechanical strength and superior thermostability.

Additionally, these thermoplastic resins have superior kneadability with magnetic powders and exhibit excellent uniformity when kneaded with the same.

When the amount of the binder resin in the DMC bonded rare-earth magnet composition is too small, the viscosity of the composition becomes high during the kneading step, and the torque during kneading is increased. As a result, exothermic reaction occurs, and the oxidation of the magnetic powder and other ingredients can be thereby promoted. When the amount of the antioxidant or the like is small as well, the oxidation of the magnetic powders and other ingredients cannot be sufficiently inhibited, the moldability of the composition becomes low due to a viscosity increase or the like in the kneaded mixture (melted resin), and therefore, a magnet having a low void ratio and high mechanical strength cannot be obtained. On the other hand, when the amount of the binder resin is excessive, although the moldability of the composition is satisfactory, the magnetic properties of the obtained magnet is lowered due to the excessive content of the binder resin in the magnet.

After dynamic magnetic compaction (DMC), the compacted magnets are cured in an oven if thermosetting resins, such as epoxies, are used as the binder; or thermally fused in a protective atmosphere at suitable temperatures if thermoplastic resins, such as nylon, are used as the binder; or sintered at 250 to 350 EC in a protective atmosphere if metals, such as Cu, are used as the binder. The curing and thermal fusion temperature depends upon the characteristics of polymers.

Specific permanent magnet alloys and suitable binders in the DMC bonded magnets of the present invention are described in Tables I and II below.

TABLE I
Chemical Compositions of Sm(Co_{w}FeᵥCuₓZr_{y})_{z}-type Alloys
Useful for Bonded Magnets

| Example | T* | Co | Fe | Cu | Zr | Smₓ(O, C)_{y} |
|---|---|---|---|---|---|---|
| A | 250 | 0.625 | 0.28 | 0.07 | 0.025 | Balance |
| E1 | 400 | 0.73 | 0.17 | 0.08 | 0.02 | Balance |
| E2 | 500 | 0.78 | 0.10 | 0.09 | 0.03 | Balance |
| E3 | 550 | 0.81 | 0.05 | 0.11 | 0.03 | Balance |

*T represents the maximum use temperature of the alloy

TABLE II
Binders used for high temperature Sm(Co_{w}FeᵥCuₓZr_{y})_{z} alloy type
bonded magnets

| Example | Binder | Melting Point |
|---|---|---|
| B1 | Nylon 12 | 178° C. |
| B2 | PPS | 280° C. |
| B3 | Zinc | 419.5° C. |
| B4 | Al | 660° C. |
| B5 | Cu | 1083° C. |

DMC bonded permanent magnets where the binder is an organic resin such as thermoplastic resins and the magnet particulate is a rare-earth magnet powder will preferably contain a chelating agent and/or an antioxidant at levels from between about 0.1 wt. % and about 2.0 wt. %. These latter additives ensure heat stability of the rare-earth bonded magnet composition during processing prior to dynamic magnetic composition including mixing, kneading, etc., thereby enabling the composition to be stably compounded. In addition, these additives tend to inactivate the rare-earth magnetic powder and hence improve the corrosion resistance of the bonded permanent magnet.

The use of chelating agents and antioxidants is particularly helpful when the binder is organic and especially when the binder is: thermoplastics, such as polyamides, polyesters, and/or polyphenylene sulfide (PPS).

Suitable magnetic powders, organic binders, chelating agents and antioxidants for use in DMC bonded permanent magnets of the present invention are listed in Table III below.

TABLE III

| | |
|---|---|
| Organic | Polyamides (such as nylon 6, nylon 6/6, nylon 12, nylon 6/12, |
| Powder | etc.) |
| | Polyesters |
| | Polyphenylene sulfide |
| | Polyethylene |
| | Polypropylene |
| | Liquid crystal polymers |
| Magnetic | Hard ferrite powder |
| powder | Alnico powder |
| | (Nd,RE)₂(Fe,TM)₁₄B-based isotropic powder |
| | (Nd,RE)₂(Fe,TM)₁₄B-based anisotropic powder |
| | (Sm,Re)(Co,TM)₅-type powder |
| | (Sm,Re)(Co,Fe,Cu,TM)₂-type powder |
| | Sm(Fe,TM)₁₇Cₓ-type powder |
| | Sm(Fe,TM₁₇Nₓ-type powder |
| | Sm(Fe,TM)₁₇(C_{1-v-w}NᵥH_{w})ₓ-type powder |
| | Nanocomposite powder consisting one or more of above listed |
| | hard magnetic phase and a soft magnetic phase such as Fe, |
| | Co, Fe₁₋ₓCox,Fe₃B, etc. |
| | Powder mixtures consisting two more above listed powders |
| | with various magnetic characteristics. |
| Anti- | 2,3-bis[[3-[3,5-di-tert-butyl-4-hydroxyphenyl]propinoyl]]- |
| oxidant | propionohydrazide |
| | Bis(2,4-dicumylphenyl)pentaerythritol diphosphite |
| | Benzenepropanoic acid,3,5-bis(1,1-dimethylethyl)-4-hydroxy- |
| | 2,2-bis[[3-[3,5-bis(1,1-dimethylethyl)-4-hydroxyphenyl]-1- |
| | oxopropoxy]-methyl]-1,3-propanediyl ester |
| | 1,3,5-trimethyl-2,4,8-tris(3,5-di-tert-butyl-4-hydroxybenzyl) |
| | benzene |
| | 2,4,8,10-Tetraoxa-3,9-diphosphaspiro(5.5)undecane,3,9,- |
| | bis[2,4-bis(1-methyl-1-phenylethyl)phenoxy2,4-bis(1-methyl- |
| | 1-phenyl-ethyl)phenol |
| | 4,4′-Butylidene-bis(3-methyl-6-t-butylphenol) |
| | N,N′-Hexamethylene-bis(3,5-t-butyl-4-hydroxy-hydrocinn- |
| | amide) |
| Chelating | N,N′-Hexamethylene-bis(3,5-t-butyl-4-hydroxy-hydrocinn- |
| agent | amide)N,N′-Diphenyloxamide |
| | N,N′-bis[[3-[3,5-di-tert-butyl-4-hydroxyphenyl]propinol]]- |
| | propionohydrazide |
| | N-Salicyloyl-N′-aldehydedehydrazine |

To protect the DMC bonded permanent magnets of the invention from high temperature, oxidative air attack and corrosives including salt, acid and alkali corrosion, coupling agents are included in the magnet particulate, binder powder mixtures. Suitable coupling agents include neoalkoxy: titanates and zirconates as described in U.S. Pat. Nos. 4,525,494; 4,555,450 and 4,715,968. Specifically, these include: neopentyl (diallyl) oxy, tri(N-ethylenediamino), ethyltitinate, tri(m-amino) phenyl zirconate and aluminates. Additional samples are described in KEN-REACT REFERENCE MANUAL, 1995, which is hereby incorporated by reference.

The amount of the coupling agent added to the permanent magnet particulate and binder mixture is preferably at a level that would have minimal interference with the magnetic characteristics of the DMC bonded magnets. The amount of coupling agent must be sufficient to impart strength.

In Table IV below, a series of DMC bonded permanent magnets are illustrated along with their maximum use temperatures. The alloy types are detailed in Table I.

TABLE IV
Compositions of the invention illustrative of DMC bonded
permanent magnets

| | Type | | | | | |
|---|---|---|---|---|---|---|
| | of | | | | | |
| | alloy | | | | | |
| | (detailed | Amount | | Amount | | Maximum |
| Ex- | in | of | Type | of | | use |
| am- | Table | alloy | of | binder | Polymer | temperature |
| ple | 1) | ( vol %) | binder | (vol %) | additives | ° C. |
| M1 | A | 85 | Nylon | 14 | 1 | 150 |
| M2 | A | 90 | Nylon | 9 | 1 | 150 |
| M3 | A | 85 | PPS | 14 | 1 | 250 |
| M4 | A | 90 | PPS | 9 | 1 | 250 |
| M5 | A | 85 | Zn | 14 | 1 | 250 |
| M6 | A | 90 | Zn | 9 | 1 | 250 |
| M7 | A | 85 | Al | 14 | 1 | 250 |
| M8 | A | 90 | Al | 9 | 1 | 250 |
| M9 | A | 85 | Cu | 14 | 1 | 250 |
| M10 | A | 90 | Cu | 9 | 1 | 250 |
| M11 | E1 | 85 | Nylon | 14 | 1 | 150 |
| M12 | E1 | 90 | Nylon | 9 | 1 | 150 |
| M13 | E1 | 85 | PPS | 14 | 1 | 250 |
| M14 | E1 | 90 | PPS | 9 | 1 | 250 |
| M15 | E1 | 85 | Zn | 14 | 1 | 380 |
| M16 | E1 | 90 | Zn | 9 | 1 | 380 |
| M17 | E1 | 85 | Al | 14 | 1 | 400 |
| M18 | E1 | 90 | Al | 9 | 1 | 400 |
| M19 | E1 | 85 | Cu | 14 | 1 | 400 |
| M20 | E1 | 90 | Cu | 9 | 1 | 400 |
| M21 | E2 | 85 | Nylon | 14 | 1 | 150 |
| M22 | E2 | 90 | Nylon | 9 | 1 | 150 |
| M23 | E2 | 85 | PPS | 14 | 1 | 250 |
| M24 | E2 | 90 | PPS | 9 | 1 | 250 |
| M25 | E2 | 85 | Zn | 14 | 1 | 380 |
| M26 | E2 | 90 | Zn | 9 | 1 | 380 |
| M27 | E2 | 85 | Al | 14 | 1 | 500 |
| M28 | E2 | 90 | Al | 9 | 1 | 500 |
| M29 | E2 | 85 | Cu | 14 | 1 | 500 |
| M30 | E2 | 90 | Cu | 9 | 1 | 500 |
| M31 | E3 | 85 | Nylon | 14 | 1 | 150 |
| M32 | E3 | 90 | Nylon | 9 | 1 | 150 |
| M33 | E3 | 85 | PPS | 14 | 1 | 250 |
| M34 | E3 | 90 | PPS | 9 | 1 | 250 |
| M35 | E3 | 85 | Zn | 14 | 1 | 380 |
| M36 | E3 | 90 | Zn | 9 | 1 | 380 |
| M37 | E3 | 85 | Al | 14 | 1 | 550 |
| M38 | E3 | 90 | Al | 9 | 1 | 550 |
| M39 | E3 | 85 | Cu | 14 | 1 | 550 |
| M40 | E3 | 90 | Cu | 9 | 1 | 550 |

The bonded magnet described in Table IV above as M10 is produced as follows; the raw materials are mixed according to the formula:

(CO_{0.625}Fe_{0.28}Cu_{0.07}Zr_{0.025})_{8.4}

described as Example A in Table 1, and then melted in an induction melting furnace. The melted liquid alloy is then poured into a Cu mold at a predetermined speed to produce an ingot with dimensions detailed in FIG. 2. About 90% volume percent of the desirable columnar grains within the ingot is obtained by adjusting the liquid alloy temperature, the speed of pouring liquid alloy into the Cu mold, the cooling rate of the ingot, etc. The ingot is solution-treated at 1140° to 1200° C. for 2 to 10 hours, and then heat-treated at 750° to 850° C. for 5 to 20 hours followed by slow cooling to 400° C. at a rate of 1° to 1.5° C./min. Above ingot is then crushed under the protection of argon atmosphere, followed by milling to get the desired particle size and distribution. The powder is then coated by Cu and polymer additives, such as lubricant, antioxidant and coupling agent, to obtain the chemical composition as described in Table IV, Example M10.

The above powder is also compacted by conventional compression molding (CCM) for purposes of comparison.

The demagnetization curves of above bonded magnets are shown in FIG. 3, where DMC bonded magnet M10 is represented by curves 3A and 3C while the CCM bonded magnet is represented by curves 3B and 3D.

The maximum energy product (BH)ₘₐₓ of the DMC bonded magnet M10 is 19 MGOe, which is 27% higher than that of the CCM bonded magnet (15 MGOe).

In Table V below, the magnetic properties of a class of high temperature performing DMC bonded magnets are described.

TABLE V
Properties of DMC Bonded Permanent Magnets

| | | 25° C. | | 300° C. | | 400° C. | | 500° C. | | 550° C. | |
|---|---|---|---|---|---|---|---|---|---|---|---|
| Example | Tm° C. | _{I}Hc | (BH)ₘₐₓ | _{I}Hc | (BH)ₘₐₓ | _{I}Hc | (BH)ₘₐₓ | _{I}Hc | (BH)ₘₐₓ | _{I}Hc | (BH)ₘₐₓ |
| M7 | 250 | 25 | 17 | 7.1 | 12 | 3.4 | 6 | 1.5 | 2 | 0.7 | 0.5 |
| M8 | | 25 | 18 | 7.1 | 13 | 3.4 | 7 | 1.5 | 3 | 0.7 | 1.5 |
| M9 | | 25 | 17 | 7.1 | 12 | 3.4 | 6 | 1.5 | 2 | 0.7 | 0.5 |
| M10 | | 23 | 19 | 7.0 | 11 | 2.1 | 4 | 0.9 | 3 | 0.3 | 1.5 |
| M17 | 400 | 34 | 13 | 14 | 10 | 8.8 | 8.5 | 4.9 | 6 | 2.1 | 2 |
| M18 | | 34 | 14 | 14 | 11 | 8.8 | 9.5 | 4.9 | 7 | 2.1 | 3 |
| M19 | | 34 | 13 | 14 | 10 | 8.8 | 8.5 | 4.9 | 6 | 2.1 | 2 |
| M20 | | 34 | 14 | 14 | 11 | 8.8 | 9.5 | 4.9 | 7 | 2.1 | 3 |
| M27 | 500 | 29 | 10 | 16 | 8 | 12.4 | 6.5 | 7.3 | 5 | 3.6 | 2.5 |
| M28 | | 29 | 11 | 16 | 9 | 12.4 | 7.5 | 7.3 | 6 | 3.6 | 3.5 |
| M29 | | 29 | 10 | 16 | 8 | 12.4 | 6.5 | 7.3 | 5 | 3.6 | 2.5 |
| M30 | | 29 | 11 | 16 | 9 | 12.4 | 7.5 | 7.3 | 6 | 3.6 | 3.5 |
| M37 | 550 | 25 | 8 | 17 | 6 | 13.2 | 4.5 | 8.8 | 3.3 | 4.7 | 2 |
| M38 | | 25 | 9 | 17 | 7 | 13.2 | 5.5 | 8.8 | 4.3 | 4.7 | 3 |
| M39 | | 25 | 8 | 17 | 6 | 13.2 | 4.5 | 8.8 | 3.3 | 4.7 | 2 |
| M40 | | 25 | 9 | 17 | 7 | 13.2 | 5.5 | 8.8 | 4.3 | 4.7 | 3 |

The magnetic properties of various DMC bonded magnets of the present invention were tested by using a KJS hysteresigraph for temperatures up to 300° C.; and by using a vibrating sample magnetometer (VSM) for temperatures from about 300° C. to about 550° C. Table V shows the magnetic properties at 25° C. to 550° C. for some examples of the invented class of SmCo magnets.

Table VI illustrates various binders and means of processing bonded magnets which are compared to dynamic magnetic compaction magnets of the invention.

TABLE VI
PRIOR ART BONDED MAGNETS COMPARED TO DMC BONDED MAGNETS
Typical Binders:
METAL BINDER: Copper, Cobalt, Nickel, Tin, Silver, Bismuth
THERMOSET RESINS: Epoxy, Acrylic, Phenolic
THERMOPLASTIC RESINS: Polyamides, Polyesters, PPS, PVC, LDPE
ELASTOMERS: Nitrile, Rubber, Vinyl

| | Compression | | | | Dynamic Magnetic |
|---|---|---|---|---|---|
| Process | Molding | Injection Molding | Extrusion Molding | Calendering | Compaction (DMC) |
| Binder | THERMOSET | THERMOPLASTIC | ELASTOMERS or | ELASTOMERS | METAL BINDERS or |
| | RESINS or | RESINS | THERMOPLASTIC | | THERMOSET RESINS or |
| | METAL BINDERS | | RESINS | | THERMOPLASTIC |
| | | | | | RESINS |
| End | Rigid | Rigid | Rigid with | Flexible | Rigid |
| Product | | | thermoplastic resins | | |
| | | | and flexible with | | |
| | | | elastomers | | |
| Magnetic Powders | Typical Maximum Energy Product (BH)ₘₐₓ(MGOe) | | | | |
| NdFeB(isotropic) | 9-10 | 4-6 | 4-8 | 3-5 | 10-14 |
| NdFeB(anisotropic) | 14-16 | N/A | N/A | N/A | 15-22 |
| SmCo₅ | 8-12 | 4-9 | 4-10 | N/A | 10-14 |
| Sm(CoCuFeZy)_{z} | 13-17 | 6-10 | 6-10 | N/A | 16-23 |
| Ferrite | N/A | 1-1.8 | 1-1.8 | 0.6-1.8 | 1.5-3.5 |
| Ferrite/NdFeB hybrids | N/A | 2-6 | 2-6 | N/A | 3-14 |
| SmFeN | 8-15 | N/A | N/A | N/A | 1-22 |

While there is no particular restriction on the average particle diameter of the magnet powder, the average particle diameter should preferably be within a range of from about 0.5 to 50 Fm, or more preferably, from 10 to 30 Fm. The average particle diameter of the magnet powder can be measured, for example, by the F.S.S.S. (Fischer sub-sieve sizer) method.

For the purposes of obtaining a satisfactory DMC with a small amount of binding resin, the particle diameter distribution of the magnet powder should preferably be dispersed to some extent. This permits reduction of the vacancy ratio of the resultant DMC bonded magnet.

The average particle diameter may differ between individual compositions of magnet particulate to be mixed. When using a mixture of two or more kinds of magnet powder of different particle diameters, sufficient mixing and kneading ensures a higher probability of achieving a state in which magnet powder particles of smaller diameters come between those of larger particle diameters, thus allowing an increased packing density of magnet powder particles within the compound, hence contributing to the improvement of magnetic properties of the resultant bonded magnet.

The DMC bonded magnets of the invention are widely applicable for automotive applications, such as starter motors, anti-lock braking systems (ABS), motor drives for wipers, injection pumps, fans and controls for windows, seats, etc. loudspeakers, eddy current breaks and alternators; telecommunication applications, such as loudspeakers, microphones, telephone ringers, electro-acoustic pick-ups, switches and relays; data processing applications, such as disc drives and actuators, stepping motors and printers; consumer electronic applications, such as DC motors for showers, washing machines, drills, citrus presses, knife sharpeners, food mixers, can openers, hair trimmers, etc., low voltage DC drives for cordless appliances such as drills, hedgecutters, chainsaws, magnetic locks for cupboards and doors, loudspeakers for TV and audio, TV beam correction and focusing devices, compact-disc drives, home computers, video recorders, electric clocks, and analogue watches; electronic and instrument applications, such as sensors, contactless switches, NMR spectrometer, energy meter disc, electromechanical transducers, crossed field tubes and flux-transfer trip devices; industrial applications, such as DC motors for magnetic tools, robotics, magnetic separators for extracting metals and ores, magnetic bearings, servo-motor drives, lifting apparatus, brakes and clutches, meters and measuring equipment; astro and aerospace applications, such as frictionless bearings, stepping motors, couplings, instrumentation, traveling wave tubes and auto-compasses; and biosurgical applications, such as dentures, orthopaedics, wound closures, stomach seals, repulsion collars, ferromagnetic probes, cancer cell separators and NMR body scanners.

Although the preferred embodiment of the structure and method of compaction of various bonded permanent magnets of the invention has been described, it will be understood that within the purview of this invention, various changes may be made in the electrical circuitry and in the current flow, therethrough, or in form, details, proportion and arrangement of parts, the combination thereof, and the method of operation, which, generally stated, consist in a structure and method within the scope of the appended claims.

Prior art bonded SmCo magnets have many disadvantages. For example, (a) prior art bonded SmCo magnets are limited to use temperatures up to about 150° C. due to the high temperature limitations of the binding polymers employed; and (2) prior art SmCo anisotropic powder exhibits non-linear extrinsic demagnetization curves at use temperatures above about 250° C. Thus, even when prior art SmCo powder is bonded with metals like Cu, these bonded magnets are limited to use below about 250° C.

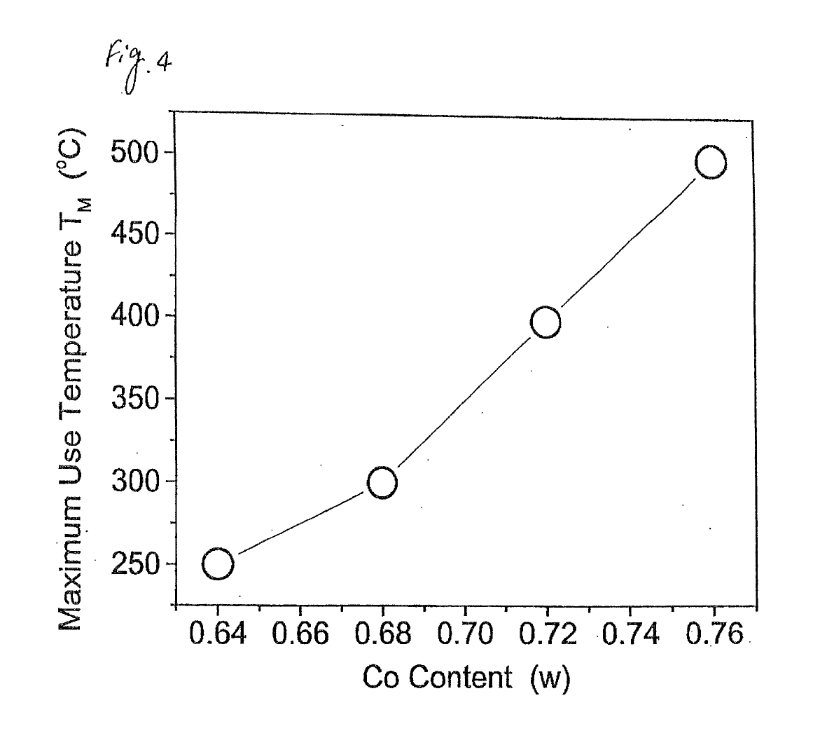

DMC bonded SmCo magnets of the invention exhibit surprising improvement in maximum use temperature. Specifically, the higher the Co content in Sm-change this-(Co_{W}Co_{X}Fe_{X}TM_{Y})Z powder, the higher the maximum use temperature for the DMC metal bonded magnets of the invention. This unexpected feature of the DMC bonded magnets of the invention is described graphically in FIG. 4 where maximum use temperature, T_{M}, in ° C., is plotted versus Co_{w} content.

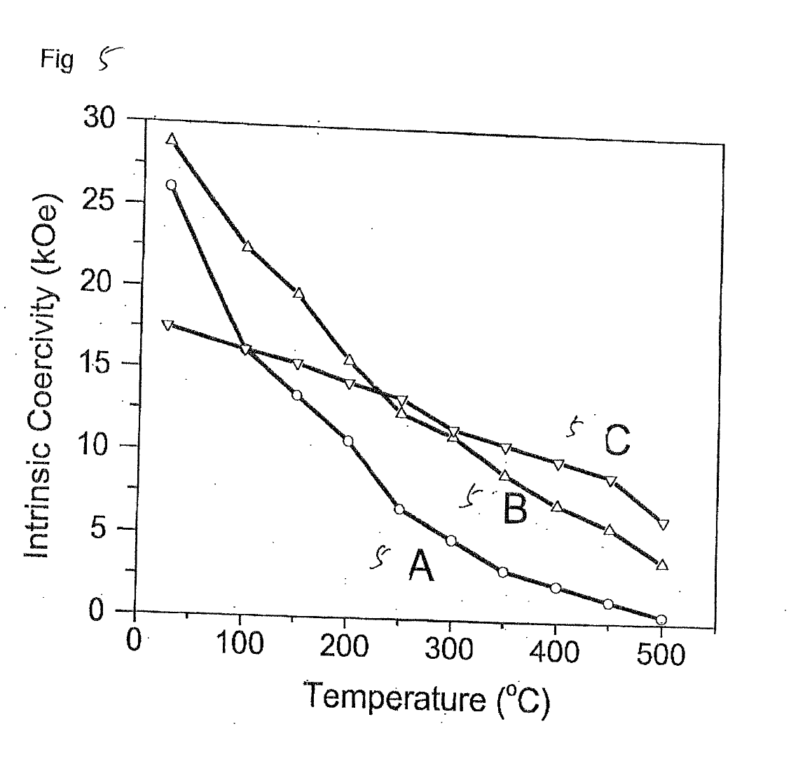

Temperature dependence of intrinsic coercivity _{I}H_{C} of DMC metal bonded SmCo magnets of the invention is illustrated in FIG. 5. Curves 5A, 5B and 5C represent the temperature dependence of intrinsic coercivity, H_{Ci}, of the specific examples from Table 1 above, A, E1 and E2, respectively. It is interesting to note that Example E2 has the highest intrinsic coercivity, H_{Ci}, at higher temperatures while indicating a lower H_{Ci} at room temperature.

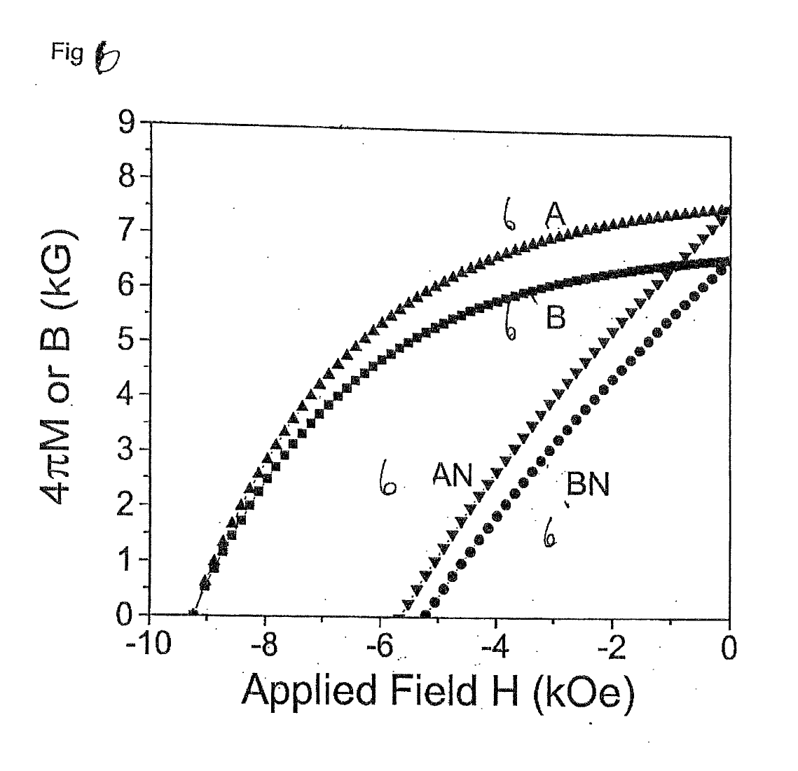

The magnetic properties of DMC bonded NdFeB magnets versus a compression molded magnet with the same composition is set out in Table VII below and further illustrated in FIG. 6, where Curves 6A/6AN represent the DMC bonded magnets and Curves 6B/6BN represent the compression molded magnets.

The composition of the two magnets to be evaluated (one DMC and the other compression molded) comprises: NdFeB isotropic powder about 98% by wt.; epoxy resin about 1.9% by wt. and lubricant about 0.1% by wt.

TABLE VII
Comparison of magnetic properties of bonded NdFeB magnets produced
by DMC and compression molding process

| | Br | (BH)ₘₐₓ | H_{C} | _{I}H_{C} |
|---|---|---|---|---|
| | (kG) | (MGOe) | (kOe) | (kOe) |
| DMC | 7.68 | 12.2 | 5.7 | 9.34 |
| Compression | 6.73 | 9.7 | 5.4 | 9.32 |
| Change in % | 14 | 26 | 6 | unchanged |

(BH)ₘₐₓ for the DMC bonded magnet is approximately 26% higher than the corresponding compression molded magnet.

The NdFeB isotropic powder used in these magnets had the particle size and distribution adjusted to optimize density. This isotropic NdFeB powder was mixed with various additives to produce the following:

| | % by wt. |
|---|---|
| NdFeB isotropic powder | 95 |
| Nylon 12 | 4.5 |
| Lubricant | 0.1 |
| Antioxidant | 0.4 |
| Coupling agent | trace |

Portions of the foregoing mixture were subjected to various compacting processes: extruding, compression and DMC. The DMC and compression molded magnets are subsequently thermally fused at 200° C. for 30 minutes. The resultant magnets are tested for intrinsic and extrinsic demagnetization curves, which are plotted as 7A/7AN, 7B/7BN and 7C/7CN, respectively. The DMC bonded magnets have higher remanence Bᵣ and therefore maximum energy product (BH)ₘₐₓ.

The present invention has been described in detail, including the preferred embodiments thereof. However, it will be appreciated that those skilled in the art, upon consideration of the present disclosure, may make modifications and/or improvements on this invention and still be within the scope and spirit of this invention as set forth in the following claims.

What is claimed is:

1. A method of manufacturing density enhanced, bonded permanent magnets having the following properties:
a. maximum energy product (BH)ₘₐₓ up to 40% greater than that of traditional, mechanical, compacted, bonded permanent magnets,
b. (BH)ₘₐₓ up to 99% of theoretical,
c. a void ratio approaching 0 volume %, and
d. a use temperature from room temperature up to about 550° C.,
said method comprising the step of compacting a mixture of permanent magnet particulates and a binder using pulsed electromagnetic forces, where each pulse has a pulse time less than the thermal time constant of the permanent magnet particulate, and wherein said compaction is achieved without adversely affecting the binder or the structure of the permanent magnet particulates.

2. A method for producing bonded permanent magnets comprising permanent magnet particulate combined with a binder, having:
a. (BH)ₘₐₓ is up to 99% of theoretical,
b. the void ratio approaches 0 volume %, and
c. the use temperature is up to about 550°, wherein dynamic magnetic
compaction (DMC) is used, and the pulse time of the DMC is less than the thermal time constant of said permanent magnet particulate;
said method comprising the following steps:
i. mixing permanent magnet particulates with a binder;
ii. subjecting said mixture to an initial compression forming force, forming a first compressed mixture; and
iii. subjecting said first compressed mixture to pulsed dynamic magnetic compaction wherein the compaction pulse time is less than the thermal time constant of said magnet particulates.

3. A method for producing bonded permanent magnets according to claim 1 or 2, wherein the permanent magnet particulate is selected from the group consisting of alnico, ferrite, samarium, cobalt and neodymium-iron-boron and mixtures thereof.

4. A method for producing bonded permanent magnets according to claim 1 or 2, wherein the binder is selected from the group consisting of organic and inorganic binders and mixtures thereof.

5. A method for producing bonded permanent magnets according to claim 1 or 2, wherein the permanent magnet particulate is isotropic.

6. A method for producing bonded permanent magnets according to claim 1 or 2, wherein the permanent magnet particulate is anisotropic.

7. A method for producing bonded permanent magnets according to claim 1 or 2, wherein said DMC is generated by a pulsed electromagnetic field at up to 100 kilo oersteds for a duration ranging from between about 0.5 milliseconds and about 2 milliseconds.

8. A method for producing bonded permanent magnets according to claim 2, wherein said permanent magnet particulate has the formula RE(Co_{w}FeᵥCuₓTM_{y})_{z} where the sum of w, v, x and y is 1 and z has a value between 5 and 8.5; RE represents a rare earth element selected from the group consisting of Sm, Y, La, Ce, Pr, Nd, Gd, Tb, Dy, Ho, Er and mixtures thereof; and TM is a transition metal selected from the group consisting of Zr, Hf, Ti, Mn, Cr, Nb, Mo, W, Ni, Ta, V and mixtures thereof, and wherein said DMC bonded permanent magnets exhibit substantially linear extrinsic demagnetization curves at use temperatures up to about 550° C.

9. A method for producing elevated temperature stable bonded permanent magnets according to claim 2, wherein said permanent magnet particulate has the formula Sm(Co_{w}FeᵥCuₓTM_{y})_{z} where the sum of w, v, x and y is 1 and z has a value between about 5 and 8.5; and TM represents a transition metal selected from the group consisting of Zr, Hf, Ti, Mn, Cr, Hb, Mo, W, Ni, Ta, V and mixtures thereof and said bonded magnets exhibit substantially linear extrinsic demagnetization curves at use temperatures up to about 550° C.

10. A method for producing bonded permanent magnets according to claim 2, wherein said permanent magnet particulate has the formula (Nd,RE)₂(Fe,TM)₁₄B.

11. A method for producing bonded permanent magnets according to claim 1 or 2, wherein traditional (BH)ₘₐₓ values are increased by up to 40%.

12. A method for producing bonded permanent magnets according to claim 1 or 2, wherein the magnetic particulates comprise average particle sizes ranging from between about 10 and about 70 microns.

13. A method for producing bonded permanent magnets according to claim 12, wherein said magnetic particulates having:
(a) discrete alloy compositions of the general formula, Sm(Co_{w}FeᵥCuₓZr_{y})_{z} where the sum of w+v+x+y is 1 and z has a value between about 5.0 and about 8.5;
(b) a critical combination of Co, Cu, Fe and other elements with a corresponding high _{I}H_{C} at elevated temperatures;
(c) high energy product, (BH)ₘₐₓ, at elevated temperatures;
(d) a substantially linear extrinsic demagnetization curve at maximum use temperatures; and
(e) a curie temperature T_{c} up to 930° C.

14. A method for producing bonded permanent magnets according to claim 8, wherein said magnetic particulates having the general formula, Sm(Co_{w}FeᵥCuₓZr_{y})_{z}, wherein:
(a) z has a value between about 5.0 and about 8.5;
(b) w has a value between about 0.50 and about 0.85;
(c) v has a value between about 0.0 and about 0.35;
(d) x has a value between 0.05 and about 0.20; and
(e) y has a value between 0.01 and about 0.05.

15. A method for producing bonded permanent magnets according to claim 8, wherein said magnetic particulates have positive or negative temperature coefficients of intrinsic coercivity ranging from between +0.3%/° C. and −0.30%/° C.

16. A method for producing bonded permanent magnets according to claim 8, wherein said magnet particulates have positive or negative temperature coefficients of residual induction ranging from between +0.02%/° C. to −0.04%/° C.

17. A method for producing bonded permanent magnets according to claim 1 or 2, wherein separate orienting and compacting pulses are employed to first orient the crystalline permanent magnet particulate and then to compact the magnet particulate and binder.

18. A method for producing bonded permanent magnets according to claim 1 or 2, wherein the permanent magnet particles have a thermal time constant T, which is equal to DC/KR² where D represents the density of said particle, C represents the heat capacity of said particle, K represents the thermal conductivity of said particle and R represents the size of said particle.

19. A method for manufacturing bonded SmCo magnets having the demagnetization curve set forth in FIG. 3 using DMC, said method comprising the following steps:
i. mixing permanent magnet particulate with a binder
ii. subjecting said mixture to an initial compression forming force, forming a first compressed mixture; and
iii. subjecting said first compressed mixture to pulsed dynamic magnetic compaction wherein the pulse time is less than the thermal time constant of said magnet particulate.

20. A method of manufacturing bonded NdFeB isotropic particulate, powder based magnet having the demagnetization curve set forth in FIG. 6 using DMC, said method comprising the following steps:
i. mixing permanent magnet particulate with a binder subjecting said mixture to an initial compression forming force, forming a first compressed mixture; and
ii. subjecting said first compressed mixture to pulsed dynamic magnetic compaction wherein the pulse time is less than the thermal time constant of said magnet particulate.

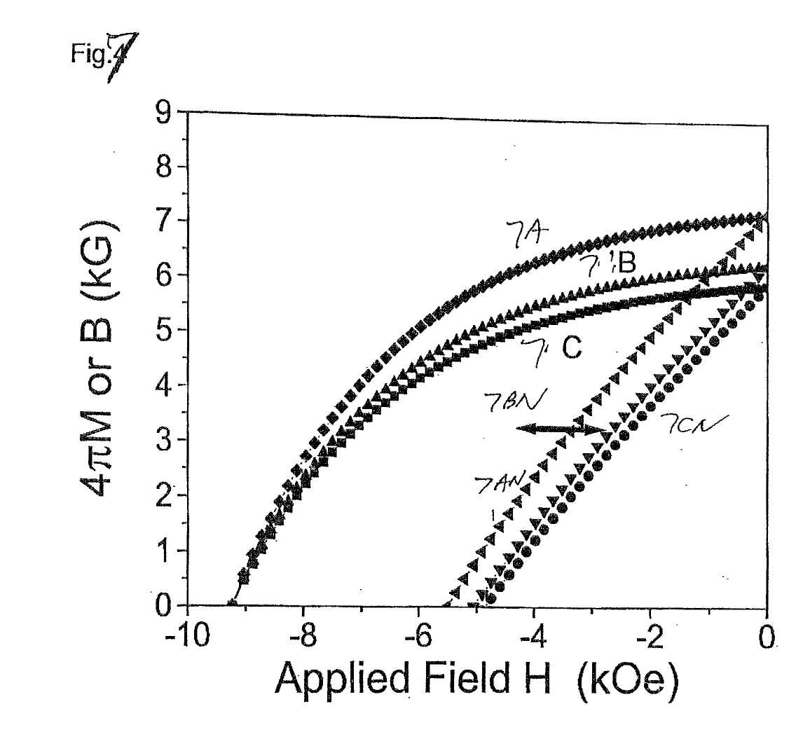

21. A method of manufacturing bonded NdFeB isotropic particulate, powder based magnet having the magnetization curve set forth in FIG. 7 using DMC, said method comprising the following steps:
i. mixing permanent magnet particulate with a binder
ii. subjecting said mixture to an initial compression forming force, forming a first compressed mixture; and
iii. subjecting said first compressed mixture to pulsed dynamic magnetic compaction wherein the pulse time is less than the thermal time constant of said magnet particulate.

22. A method of manufacturing bonded permanent magnets having the formula Sm(Co_{W}Co_{X}Fe_{Y}TM_{Y})_{Z} according to claim 7 having increased Co levels with the corresponding maximum use temperatures as shown in FIG. 4 using pulsed DMC.

23. A method of manufacturing bonded SmCo magnets having the intrinsic coercivity, _{I}H_{C}, values at varying temperatures as set forth in FIG. 5 using DMC, said method comprising the following steps:
i. mixing permanent magnet particulate with a binder
ii. subjecting said mixture to an initial compression forming force, forming a first compressed mixture; and
iii. subjecting said first compressed mixture to pulsed dynamic magnetic compaction wherein the pulse time is less than the thermal time constant of said magnet particulate.
